(19) United States
(12) Patent Application Publication
(10) Pub. No.: US 2007/0030452 A1
(43) Pub. Date: Feb. 8, 2007

(54) IMAGE ADAPTATION SYSTEM AND METHOD

(75) Inventor: John Dick Gilbert, Applegate, OR (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: N-LIGHTEN TECHNOLOGIES, Mountain View, CA (US)

(21) Appl. No.: 11/164,814

(22) Filed: Dec. 6, 2005

Related U.S. Application Data
(60) Provisional application No. 60/706,703, filed on Aug. 8, 2005.

(51) Int. Cl. G03B 1/00

(52) U.S. Cl. 352/166

(57) ABSTRACT

A system a method for correcting for optical distortions on a projection screen adapts a projection image to match an input image by adjusting the content of output pixels.

### CROSS-REFERENCE TO RELATED APPLICATION

This application claims benefit of and incorporates by reference U.S. Patent Application No. 60/706,703 filed Aug. 8, 2005 by inventor John Gilbert.

### TECHNICAL FIELD

This invention relates generally to projection display, and more particularly, but not exclusively, provides a system and method for adapting an input image to a projection display.

### BACKGROUND

One of the most efficient methods for making a large display is to use projected images. Conventionally, the most advanced projection systems use imaging devices such as digital micro-mirror (DMD), Liquid Crystal on Silicon (LCoS), or transmissive LCD micro-displays. Typically, one or two fold mirrors are used in projection displays in order to fold the optical path and make a portion of it vertical to reduce the cabinet depth of projection displays. In a single fold mirror rear projection display, the light engine converts digital images to optical images with one or more microdisplays, and then projects the optical image to a large mirror which relays the optical images through a rear projection screen to a viewer in front of the screen. The light engine also manages light colors to yield full color images and magnifies the image. In a two fold mirror rear projection display, the projected optical images from the light engine are reflected off of a first fold mirror to a second fold mirror, and then through the rear projection screen to a viewer. The two fold mirror structure provides additional reduction in TV cabinet depth over one fold mirror structures, but typically requires additional cabinet height below the screen. The height of the cabinet below the screen is called chin height and it grows as the light engine projects to a first fold mirror typically positioned below the screen.

Because the imaging devices in projection displays are small, typically less than 1″ in diagonal, they are inexpensive to manufacture. However, the small images generated by the imaging devices require magnification factors up to 100 in order to yield the 50″-80″ diagonal image typical in consumer projection televisions. However, magnification and alignment issues can cause distortion of the image. For example, output pixels at the top end of a display can be larger than output pixels at a bottom end of a screen. Accordingly, a projected image may not match or have the same resolution as an input image to the imaging device. Also in an effort to make thinner projection televisions, the mirror system may be made more parallel to the screen, causing extensive keystoning of the image. And in an effort to make a less expensive projection system, plastic optical parts such as lens and mirrors may be used, and correspondingly, the image will suffer the abnormal and non-linear geometric and color distortions introduced by such elements.

Therefore, a new system and method are needed that efficiently and cost effectively corrects for optical distortions in projection displays.

### SUMMARY

Embodiments of the invention provide a system and method that enable the inexpensive altering of video content to correct for optical distortion in real-time. Embodiments do not require a frame buffer and there is no frame delay, e.g., embodiments are bufferless. Embodiments operate at the pixel clock rate and can be described as a pipleline for that reason. For every pixel in—there is a pixel out.

Embodiments of the invention work for up-sampling or down-sampling uniformly well. It does not assume a uniform spatial distribution of output pixels. Further, embodiments use only one significant mathematical operation, a divide. It does not use complex and expensive floating point calculations as do conventional image adaptation systems.

In an embodiment of the invention, the method comprises: acquiring output pixel centroids for a plurality of output pixels; determining adjacent output pixels of a first output pixel from the plurality; determining an overlay of the first output pixel over virtual pixels corresponding to an input video based on the acquired output pixel centroids and the adjacent output pixels; determining content of the first output pixel based on content of the overlaid virtual pixels; and outputting the determined content to a light engine for projection.

In an embodiment of the invention, the system comprises an output pixel centroid engine, an adjacent output pixel engine communicatively coupled to the output pixel centroid engine, an output pixel overlay engine communicatively coupled to the adjacent output pixel engine, and an output pixel content engine communicatively coupled to the output pixel overlay engine. The adjacent output pixel engine determines adjacent output pixels of a first output pixel from the plurality. The output pixel overlay engine determines an overlay of the first output pixel over virtual pixels corresponding to an input video based on the acquired output pixel centroids and the adjacent output pixels. The output pixel content engine determines content of the first output pixel based on content of the overlaid virtual pixels and outputs the determined content to a light engine for projection.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an image processing system according to an embodiment of the invention;

FIG. 2 is a block diagram illustrating an image processor of FIG. 1;

FIG. 3 is a diagram illustrating a viewing area of a screen;

FIG. 4 is a diagram illustrating mapping of output pixels onto a virtual pixel grid of the screen;

FIG. 5 is a diagram illustrating centroid input from an external source;

FIG. 6 is a diagram illustrating an output pixel corner calculation;

FIG. 7 is a diagram illustrating pixel sub-division overlay approximation; and

FIG. 8 is a flowchart illustrating a method of adapting for optical distortions.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

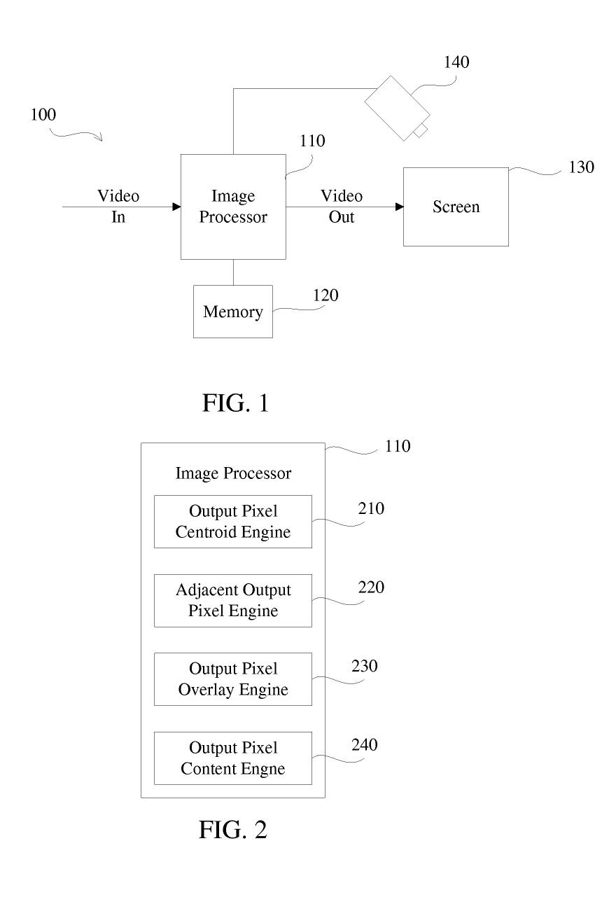

FIG. 1 is a block diagram illustrating an image processing system 100 according to an embodiment of the invention. The system 100 includes an image processor 110 communicatively coupled to a memory 120. The image processor 110 is also communicatively coupled to a camera or other imaging device 140 that images a projection screen 130. During operation, the image processor 110 receives video data, comprising single color content data for individual pixels, adapts it, and then outputs it to a light engine (not shown) for display on a screen 130. Other data received by the image processor 110 can include a pixel clock (PCLK) and control signals (VS—Vertical Sync, HS—Horizontal Sync, and DE—Data Enable).

Specifically, the image processor 110, as will be discussed further below, maps an original input video frame to an output video frame by matching output pixels on a screen to virtual pixels that correspond with pixels of the original input video frame. The image processor 110 uses the memory 120 for storage of pixel centroid information and/or any operations that require temporary storage. The image processor 110 can be implemented as software or circuitry, such as an Application Specific Integrated Circuit (ASIC). The image processor 110 will be discussed in further detail below. The memory 120 can include Flash memory or other memory format. In an embodiment of the invention, the system 100 can include a plurality of image processors 110, one for each color (red, green, blue) and/or other content (e.g., brightness) that operate in parallel to adapt an image for output.

FIG. 2 is a block diagram illustrating the image processor 110 (FIG. 1). The image processor 110 comprises an output pixel centroid engine 210, an adjacent output pixel engine 220, an output pixel overlay engine 230, and an output pixel content engine 240. The output pixel centroid engine 210 determines the center of an output pixel relative to a virtual grid of pixels by causing a test pattern (e.g., squares) to be displayed on the screen 130 and for the camera 140 to image the screen during the display of the test pattern. The test pattern and output pixel centroid determination can occur after manufacture, after home installation, at power-on, etc. The output pixel centroid locations can then be stored in the memory 120 by the output pixel centroid engine 210 so that the locations do not need to be re-determined. In an embodiment of the invention, the centroid locations are encoded with a storage algorithm to reduce the memory requirements for storing the locations. The output pixel centroid engine 210 reads out centroid locations into FIFO memories (e.g., internal to the image processor or elsewhere) corresponding to relevant lines of the input video. Only two lines plus three additional centroids need to be stored at a time, thereby further reducing memory requirements.

The adjacent output pixel engine 220 then determines which output pixels are diagonally adjacent to the output pixel of interest by looking at diagonal adjacent output pixel memory locations in the FIFOs. The output pixel overlay engine 230, as will be discussed further below, then determines which virtual pixels are overlaid by the output pixel. The output pixel content engine 240, as will be discussed further below, then determines the content (e.g., color, brightness, etc.) of the output pixel based on the content of the overlaid virtual pixels.

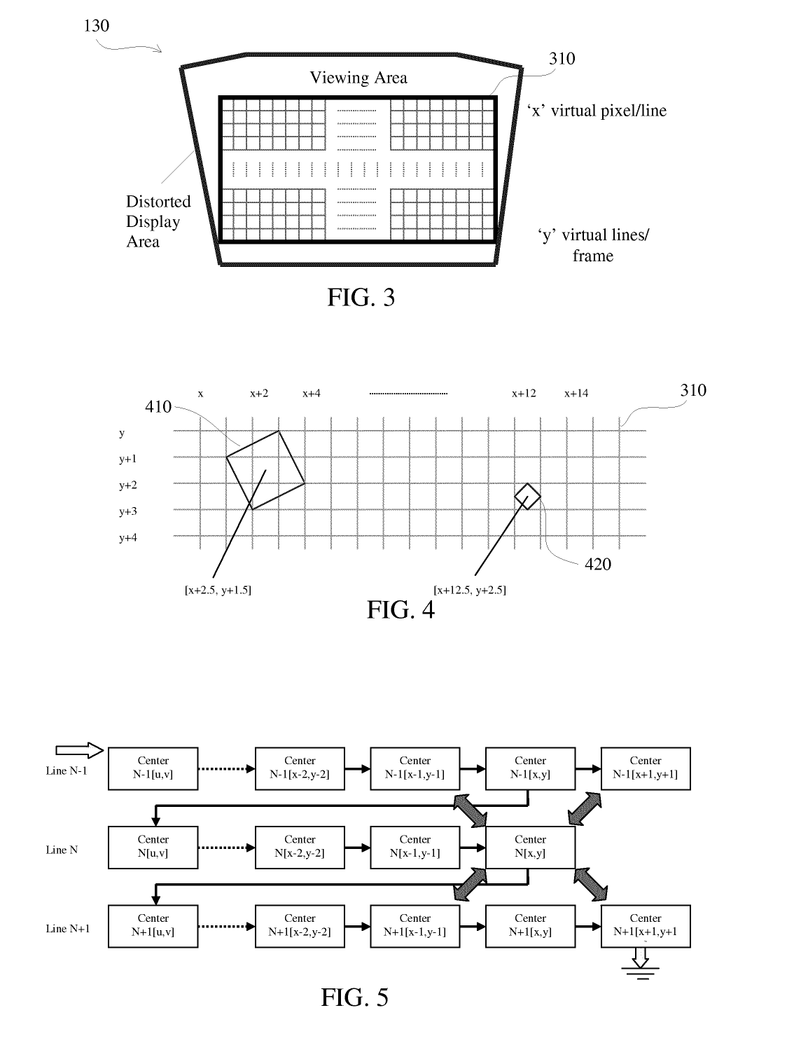

FIG. 3 is a diagram illustrating a viewing area 310 of the screen 130. The screen 130 comprises a distorted display area with a viewing area 310 therein. The viewing area 310 (also referred to herein as virtual pixel grid) comprises an x by y array of virtual pixels that correspond to an input video frame (e.g., each line has x virtual pixels and there are y lines per frame). The virtual pixels of the viewing area 310 correspond exactly with the input video frame. In an embodiment of the invention, the viewing area can have a 16:9 aspect ratio with 1280 by 720 pixels or a 4:3 ratio with 640 by 480 pixels.

Within the optically Distorted Display Area of the screen 130, the number of actual output pixels matches that of the output resolution. Within the viewing area 310, the number of virtual pixels matches the input resolution, i.e., the resolution of the input video frame, i.e., there is a 1:1 correspondence of virtual pixels to pixels of the input video frame. There may not be a 1:1 correspondence of virtual pixels to output pixels however. For example, at the top of the viewing area 310, there may several virtual pixels for every output pixel and at the bottom of the viewing area 310 there may be a 1:1 correspondence (or less) of virtual pixels to output pixels. Further, the spatial location and size of output pixels differs from virtual pixels in a non-linear fashion. Embodiments of the invention have the virtual pixels look like the input video by mapping of the actual output pixels to the virtual pixels. This mapping is then used to resample the input video such that the display of the output pixels causes the virtual pixels to look identical to the input video pixels, i.e., to have the output video frame match the input video frame so as to view the same image.

FIG. 4 is a diagram illustrating mapping of output pixels onto a virtual pixel grid 310 of the screen 130. As embodiments of the invention enable output pixel content to create the virtual pixels viewed, the output pixel mapping is expressed in terms (or units) of virtual pixels. To do this, the virtual pixel array 310 can be considered a conceptual grid. The location of any output pixel within this grid 310 can be expressed in terms of horizontal and vertical grid coordinates.

Note that by locating an output pixel's center within the virtual pixel grid 310, the mapping description is independent of relative size differences, and can be specified to any amount of precision. For example, a first output pixel 410 is about four times as large as a second output pixel 420. The first output pixel 410 mapping description can be x+2.5, y+1.5, which corresponds to the center of the first output pixel 410. Similarly, the mapping description of the output pixel 420 can be x+12.5, y+2.5.

This is all the information that the output pixel centroid engine 210 need communicate to the other engines, and it can be stored in lookup-table form or other format (e.g., linked list, etc.) in the memory 120 and outputted to a FIFO for further processing. All other information required for image adaptation can be derived, or is obtained from the video content, as will be explained in further detail below.

At first glance, the amount of information needed to locate output pixels within the virtual grid appears large. For example, if the virtual resolution is 1280×720, approximately 24 bits is needed to fully track each output pixel centroid. But, the scheme easily lends itself to significant compaction (e.g. one method might be to fully locate the first pixel in each output line, and then locate the rest via incremental change).

In an embodiment of the invention, the operation to determine pixel centroids performed by the camera or imaging device 140 can provide a separate guide for each pixel color. This allows for lateral color correction during the image adaptation. Other encoded information is possible as well, such as brightness non-uniformity.

FIG. 5 is a diagram illustrating centroid input from an external source. Centroid acquisition is performed real-time—each centroid being retrieved in a pre-calculated format from external storage, e.g., from the memory 120.

Conceptually, as centroids are acquired by the output pixel centroid engine 210, the engine 210 stores the centroids in a set of line buffers. These line buffers also represent a continuous FIFO (with special insertions for boundary conditions), with each incoming centroid entering at the start of the first FIFO, and looping from the end of each FIFO to the start of the subsequent one.

The purpose of the line buffer oriented centroid FIFOs is to facilitate simple location of adjacent centroids for corner determination by the adjacent output pixel engine 220. With the addition of an extra ‘corner holder’ element off the end of line buffers preceding and succeeding the line being operated on, corner centroids are always found in the same FIFO locations relative to the centroid being acted upon.

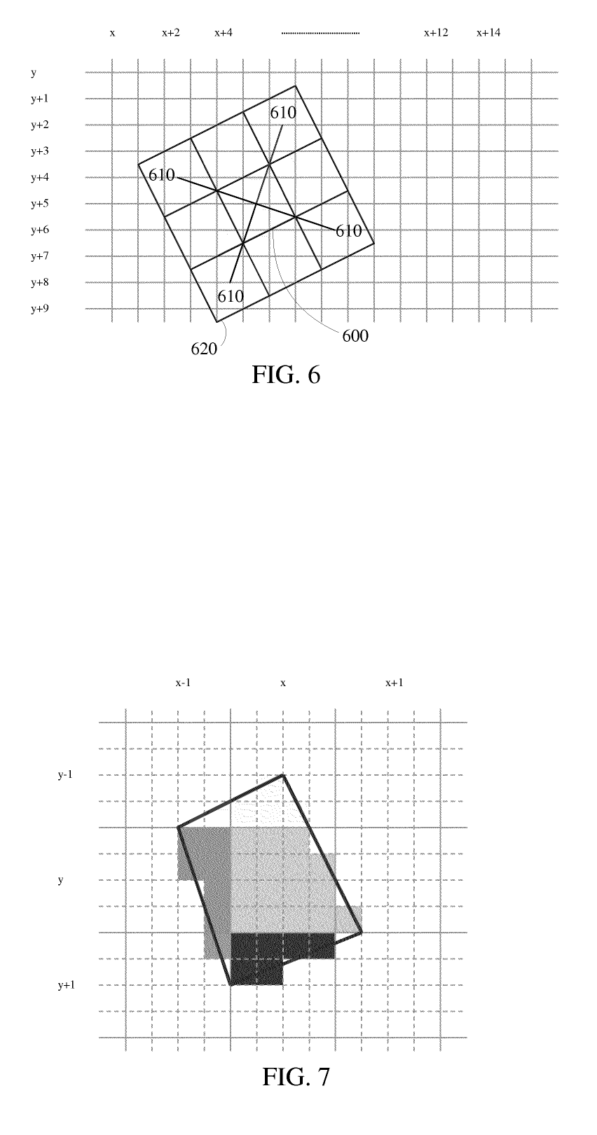

FIG. 6 is a diagram illustrating an output pixel corner calculation. Embodiments of the image adaptation system and method are dependent on a few assumptions:
Output pixel size and shape differences do not vary significantly between adjacent pixels.
Output pixels do not offset in the ‘x’ or ‘y’ directions significantly between adjacent pixels.
Output pixel size and content coverage can be sufficiently approximated by quadrilaterals.
Output quadrilateral estimations can abut each other.

These assumptions are generally true in a rear projection television.

If the above assumptions are made, then the corner points for any output pixel quadrilateral approximation (in terms of the virtual pixel grid 310) can be calculated by the adjacent output pixel engine 220 on the fly as each output pixel is prepared for content. This is accomplished by locating the halfway point 610 to the centers of all diagonal output pixels, e.g., the output pixel 620.

Once the corners are established, the overlap with virtual pixels is established by the output pixel overlay engine 230. This in turn creates a direct (identical) overlap with the video input.

Note that in the above instance the output pixel quadrilateral approximation covers many virtual pixels, but it could be small enough to lie entirely within a virtual pixel, as well, e.g., the output pixel 420 (FIG. 4) lies entirely within a virtual pixel.

Note also that in order to pipeline processing, each upcoming output pixel's approximation corners could be calculated one or more pixel clocks ahead by the adjacent output pixel engine 220.

Once the spatial relationship of output pixels to virtual pixels is established, content determination can be calculated by the output pixel content engine 240 using well-established re-sampling techniques.

Variations in output pixel size/density across the viewing area 310 mean some regions will be up-sampled, and others down-sampled. This may require addition of filtering functions (e.g. smoothing, etc.). The filtering needed is dependent on the degree of optical distortion.

The optical distortions introduced also provide some unique opportunities for improving the re-sampling. For example, in some regions of the screen 130, the output pixels will be sparse relative to the virtual pixels, while in others the relationship will be the other way around. This means that variations on the re-sampling algorithm(s) chosen are possible.

The information is also present to easily calculate the actual area an output pixel covers within each virtual pixel (since the corners are known). Variations of the re-sampling algorithm(s) used could include weightings by ‘virtual’ pixel partial area coverage, as will be discussed further below.

FIG. 7 is a diagram illustrating pixel sub-division overlay approximation. As noted earlier, one possible algorithm for determining content is to approximate the area covered by an output pixel across applicable virtual pixels, calculating the content value of the output pixel based on weighted values associated with each virtual pixel overlap.

However, calculating percentage overlap accurately in hardware requires significant speed and processing power. This is at odds with the low-cost hardware implementations required for projection televisions.

In order to simplify hardware implementation, the output pixel overlay engine 230 determines overlap through finite sub-division of the virtual pixel grid 310 (e.g., into a four by four subgrid, or any other sub-division, for each virtual pixel), and approximates the area covered by an output pixel by the number of sub-divisions overlaid.

Overlay calculations by the output pixel overlay engine 230 can be simplified by taking advantage of some sub-sampling properties, as follows:
All sub-division samples within the largest rectangle bounded by the output pixel quadrilateral approximation are in the overlay area.
All sub-division samples outside the smallest rectangle bounding the output pixel quadrilateral approximation are not in the overlay area.
A total of ½ the sub-division samples between the two bounding rectangles previously described is a valid approximation for the number within the overlay area.

The output pixel content engine 240 then determines the content of the output pixel by multiplying the content of each virtual pixel by the number of associated sub-divisions overlaid, adding the results together, and then dividing by the total number of overlaid sub-divisions. The output pixel content engine 240 than outputs the content determination to a light engine for displaying the content determination.

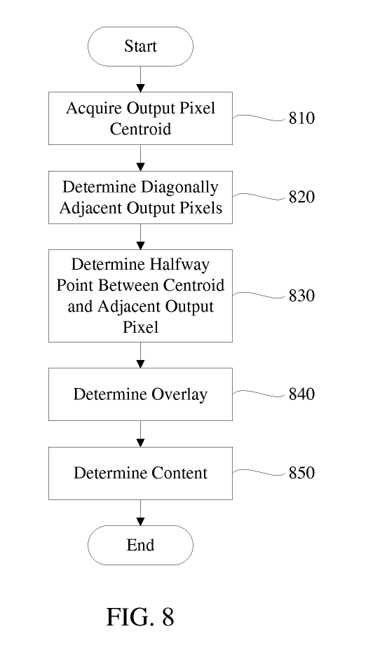

FIG. 8 is a flowchart illustrating a method 800 of adapting for optical distortions. In an embodiment of the invention, the image processor 110 implements the method 800. In an embodiment of the invention, the image processor 110 or a plurality of image processors 110 implement a plurality of instances of the method 800 (e.g., one for each color of red, green and blue). First, output pixel centroids are acquired (810) either by reading them from memory into FIFOs (e.g., three rows maximum at a time) if previously stored or determining the centroids by projecting test images, such as test patterns, onto a display and imaging them. After the acquiring (810), the diagonally adjacent output pixels to an output pixel of interest are determined (820) by looking at the diagonally adjacent memory locations in the FIFOs. The halfway point between diagonally adjacent pixels and the pixel of interest is then determined (830). An overlay is then determined (840) of the output pixel over virtual pixels and output pixel content determined (850) based on the overlay. The determined output pixel content can then be outputted to a light engine for projection onto a display. The method 800 then repeats for additional output pixel until content for all output pixels are determined (850).

The foregoing description of the illustrated embodiments of the present invention is by way of example only, and other variations and modifications of the above-described embodiments and methods are possible in light of the foregoing teaching. For example, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
acquiring output pixel centroids for a plurality of output pixels;
determining adjacent output pixels of a first output pixel from the plurality;
determining an overlay of the first output pixel over virtual pixels corresponding to an input video based on the acquired output pixel centroids and the adjacent output pixels;
determining content of the first output pixel based on content of the overlaid virtual pixels; and
outputting the determined content to a light engine for projection.

2. The method of claim 1, wherein the acquiring reads up to three rows of output pixel centroids into FIFOs.

3. The method of claim 2, wherein the determining adjacent output pixels determines diagonally adjacent output pixels.

4. The method of claim 3, wherein the determining diagonally adjacent output pixels comprises reading diagonally adjacent locations in the FIFOs.

5. The method of claim 1, wherein determining the overlay comprises subdividing the virtual pixels into at least two by two sub-regions and determining the number of sub-regions from each virtual pixel that is overlaid by the output pixel.

6. The method of claim 1, wherein the determining content is for a single color.

7. The method of claim 6, wherein the determining content and the outputting are repeated for additional colors.

8. The method of claim 1, wherein the determining content uses only one significant mathematical operation.

9. The method of claim 8, wherein the mathematical operation includes a divide.

10. The method of claim 1, wherein the method is operated as a pipeline.

11. A system, comprising:
an output pixel centroid engine capable of acquiring output pixel centroids for a plurality of output pixels;
an adjacent output pixel engine, communicatively coupled to the output pixel centroid engine, capable of determining adjacent output pixels of a first output pixel from the plurality;
an output pixel overlay engine, communicatively coupled to the adjacent output pixel engine, capable of determining an overlay of the first output pixel over virtual pixels corresponding to an input video based on the acquired output pixel centroids and the adjacent output pixels; and
an output pixel content engine, communicatively coupled to the output pixel overlay engine, capable of determining content of the first output pixel based on content of the overlaid virtual pixels and capable of outputting the determined content to a light engine for projection.

12. The system of claim 11, wherein the output pixel centroid engine acquires reading up to three rows of output pixel centroids into FIFOs.

13. The system of claim 12, wherein the adjacent output pixel engine determines adjacent output pixels by determining diagonally adjacent output pixels.

14. The system of claim 13, wherein the adjacent output pixel engine determines diagonally adjacent output pixels by reading diagonally adjacent memory locations in the FIFOs.

15. The system of claim 11, wherein the output pixel overlay engine determines the overlay by subdividing the virtual pixels into at least two by two sub-regions and determining the number of sub-regions from each virtual pixel that is overlaid by the output pixel.

16. The system of claim 11, wherein the output pixel content engine determines content for a single color.

17. The system of claim 16, wherein the output pixel content engine determines content and outputs the determined content for additional colors.

18. The system of claim 11, wherein the output pixel content engine determines content using only one significant mathematical operation.

19. The system of claim 18, wherein the mathematical operation includes a divide.

20. The system of claim 11, wherein the system is a pipeline system.

21. A system, comprising:
means for acquiring output pixel centroids for a plurality of output pixels;
means for determining adjacent output pixels of a first output pixel from the plurality;
means for determining an overlay of the first output pixel over virtual pixels corresponding to an input video based on the acquired output pixel centroids and the adjacent output pixels;
means for determining content of the first output pixel based on content of the overlaid virtual pixels; and
means for outputting the determined content to a light engine for projection.
